(19) United States
(12) Patent Application Publication
(10) Pub. No.: US 2007/0266325 A1
(43) Pub. Date: Nov. 15, 2007

(54) SYSTEM AND METHOD FOR DELIVERING PRESENTATIONS

(75) Inventors: Michael Andrew Helm, Vancouver (CA); Kevin Thomas Reay, High River (CA)

Correspondence Address: VERMETTE & CO., SUITE 320 - 1177 WEST HASTINGS STREET, VANCOUVER, BC, V6E2K3, CA

(73) Assignee: DITTOWARE INC., Vancouver (CA)

(21) Appl. No.: 11/309,239

(22) Filed: Jul. 17, 2006

Related U.S. Application Data
(60) Provisional application No. 60/699,510, filed on Jul. 15, 2005.

(30) Foreign Application Priority Data
Jul. 15, 2005 (US) 60/699,510

(51) Int. Cl. G06F 3/00

(52) U.S. Cl. 715/733

(57) ABSTRACT

method and system for the real time delivery of interactive presentations, comprising establishment of a network connection between a viewer terminal and a presenter terminal, wherein presentations are comprised of presentation information and control criteria. By selecting control criteria at the presenter terminal and the viewer terminal, the viewer and presenter may select or otherwise affect the presentation information which is displayed at the terminals.

### RELATED APPLICATIONS

This application claims the benefit of U.S. Provisional Application No. 60/699,510, filed Jul. 15, 2005.

### FIELD OF THE INVENTION

The invention relates generally to methods and systems for delivering presentations, and more specifically, relates to improved methods and systems for delivering presentations over communication networks.

### BACKGROUND OF THE INVENTION

Presentations may be conducted for various reasons, including educational, or sales related purposes. Traditionally, presentations consisted of slides, which were placed on transparencies, that were then projected onto a surface using an overhead projector. However, with the ever increasing growth and acceptance of computer technology, computer applications, such as Microsoft PowerPoint™ are used to allow for customized presentations to be created, edited and delivered via computers.

Once a presentation has been created, it may be shared with individuals through different means. One such method is the use of a projector which will be connected to the computing device upon which the presentation is stored. The projector will then output the presentations such that they are viewable to those in close proximity to the projector.

It is often desirable that presentations be shared with those who are not able to view the presentation in person. As a result, technologies have been developed that allow for presentations to be delivered to people in remote locations. Such technologies allow for sharing of presentations over networks, however they are difficult to set up and configure.

Conventional methods of delivering and sharing presentations, such as those mentioned above, do not take into account the need to deliver customized presentations to users. The presenter when preparing the presentation will have prepared one presentation that will be viewed by all the viewers. The presenter will not have control over the presentation in terms of delivering customized content suitable for a particular viewer as both the presenter and viewer share the same presentation. Therefore, the presenter will have to determine the order and sequencing order associated with the presentation content prior to the presentation being delivered to viewers.

Furthermore, conventional means of delivering presentations do not allow for interaction between the presenter and viewers. A viewer cannot ask questions. And the presenter is not able to observe the viewer's actions and provide answers or customized guidance or information to the viewer. Such direct interaction between viewer and presenter has in the past been limited to “live” presentations such as seminars delivered in person or by videoconference (as opposed to pre-authored presentations delivered to viewers at remote locations).

### SUMMARY OF THE INVENTION

The invention is a method, system and software for authoring and delivering real time interactive presentations for communicating ideas using a network or the Internet.

A presenter and one or more viewers will share a presentation session. A presenter conducts a presentation for at least one viewer, where the presenter is able to specify the presentation information that is viewable by the viewer. The presentation information may be any type of content and may include any combination of the following: audio, video, graphics, text, documents, slides, and spreadsheets. The presenter and the viewer are each provided with control criteria so as to be able to control the presentation. The presenter's control criteria allow the presenter to specify the order and layout of the presentation information that is viewed by the viewer (e.g. in response to questions or preferences expressed by the viewer(s)). The viewer's control criteria allow the viewer to influence the order and layout of the presentation (e.g. by asking questions, requesting a repeat of a slide or segment, skipping one or more sections, choosing between options, etc.). The control criteria available to the presenter is generally different from the control criteria available to the viewer, although there will generally be some overlap (generally, more presentation information and control criteria are available to the presenter than to the viewer). The presenter and viewer share a presentation session through a network connection.

In a preferred embodiment a presenter presents pre-authored presentation information to one or more viewers. The presenter sees presentation information including text-based script or prompts that the presenter reads to the viewer (e.g. over the phone or the network connection), while the viewer is shown presentation information in the form of slides that visually convey the message of the script, (the presenter can also view the presentation information available to the viewer). The viewer is able to interact with the presentation and affect the course thereof via control criteria (e.g. buttons on the slides), and the presenter is able to respond to the viewer and/or lead the viewer via control criteria. The presentation is interactive in that selection of a control criterion by a user (i.e. a presenter or a viewer) has a direct effect on presentation information presented.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 is a block diagram of the components of the presentation system;

FIG. 2 is a block diagram of the components of the presenter and viewer terminals;

FIG. 3 is a block diagram of the components of the server;

FIG. 4 is a block diagram of the components of the class library;

FIG. 5 is a block diagram of the components of the administrator application;

FIG. 6 is a flowchart illustrating the steps of a presentation creation method;

FIG. 7 is an exemplary representation of a slide creator window;

FIG. 8 is a block diagram of the components of the projector application;

FIG. 9 is a flowchart illustrating the steps of a presentation sharing method;

FIG. 10 is an exemplary representation of a presenter authentication window;

FIG. 11 is an exemplary representation of a viewer list window;

FIG. 12 is an exemplary representation of a presentation selection window;

FIG. 13 is an exemplary representation of a presenter control window;

FIG. 14 is an exemplary embodiment of a viewer authentication window;

FIG. 15 is a flowchart illustrating the steps of a presentation conduction method; and

FIG. 16A and FIG. 16B show another exemplary embodiment of a presentation control window and the presentation being viewed by the viewer.

### DETAILED DESCRIPTION OF THE INVENTION

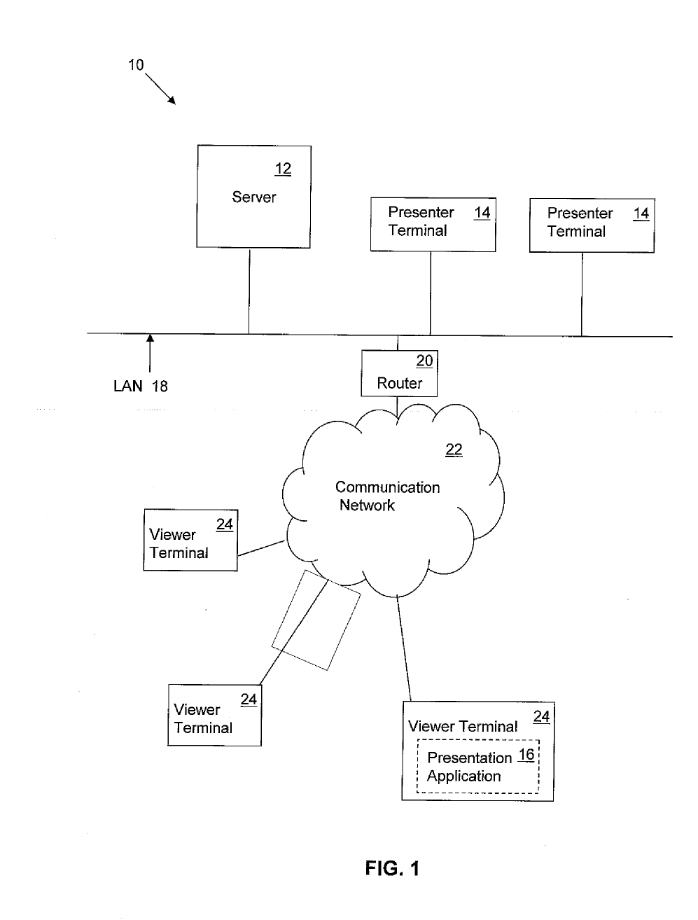

Reference is now made to FIG. 1, where the components of a presentation system 10 of the present invention are shown. The presentation system 10, in one exemplary embodiment is comprised of one or more servers 12, one or more presenter terminals 14, a local area network (LAN) 18, a router 20, a communication network 22, and one or more viewer terminals 24. A router 20 is connected to the LAN to allow for access to a communication network 22. One or more presenter terminals 24 are able to connect to the communication network 22.

The server 12 is a server type computer that has functionality which allows for a network connection. The constituent components of the server 12 as associated with the system 10 are described in greater detail below.

The presenter terminal 14 is any communication device, such as a personal computer, slim line computer, laptop, television, personal digital assistant (PDA), or any other such computing device that has means that allow for a network connection.

The presenter and viewer terminals 14 and 24, respectively may have access to or have installed upon them a presentation application 16. The presentation application 16 may be a dedicated software application, or may be similar to a plug-in that is associated with the Internet, such as for example MacroMedia™ Flash Player. The presentation application 16 allows for presentations to be shared between presenter terminals 14 and viewer terminals 24. More specifically, presentations are conducted by a presenter at a presenter terminal 14, and are viewed by viewers at viewer terminals 24. In an exemplary embodiment, the presenter terminal 14 and viewer terminal 24 view presentations through use of a web browser.

The router 20 connects to the LAN 18, and allows the server 12 and presenter terminal 14 to communicate with external devices and networks. As is understood in the art, each device such as a server or terminal that is connected to the LAN 18 is assigned either a dynamic or static IP (internet protocol) address.

The communication network 22 may be any type of network that allows for the exchange of data. The communication network 22 that is described herein, generally refers to the Internet. The communication network 22 may also be a network which allows for terminals to be connected via cable, wire or wireless means, such as via a digital cable network.

The viewer terminal 24 is any communication device, such as a personal computer, laptop computer, slim line computer, television, PDA, or any other such device, that is able to connect to a communication network 22.

In alternative embodiments, the presenter terminal 14 may communicate with the server 12 through a communication network, and need not be coupled via a LAN 18 or other similar connection to the server 12.

Presentations as used herein, refer to presentations which include various forms of content. Presentations are comprised of presentation information and control criteria. Presentation information refers to the content that is included in a presentation, which may include, but is not limited to, graphics of any form, text, tables, spreadsheets, documents, slides, audio and video. Control criteria refer to the controls included in the presentation which allow the presenter and viewer(s) to control the layout, content and the order of the presentation.

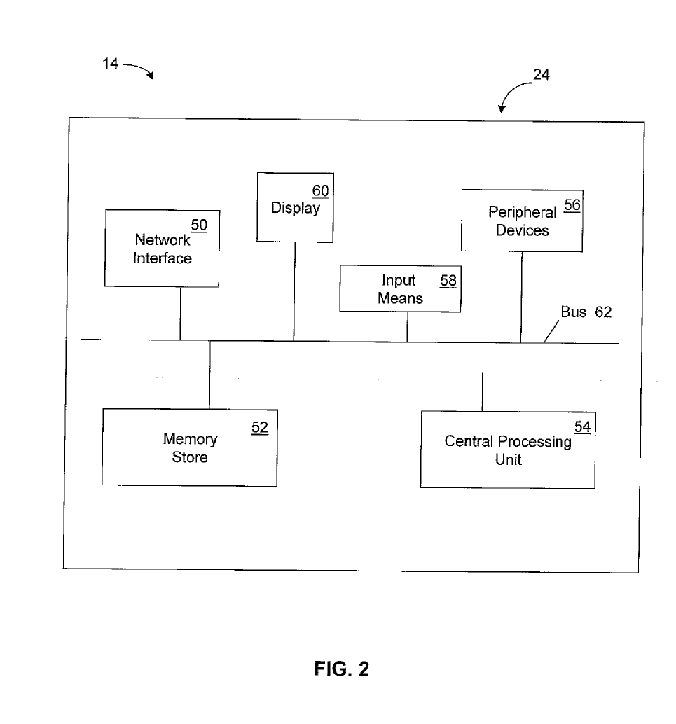

Reference is made to FIG. 2, where the general components of both the presenter terminal 14 and viewer terminal 24 are shown. The components include a network interface 50, a memory store 52, a central processing unit (CPU) 54, peripheral devices 56, an input means 58, a display terminal 60, and a bus 62. The network interface 50 enables the respective terminal to be connected to the communication network 20. The network interface 50, may be a conventional network card, such as an Ethernet card, or any other means by which the communication network 22 may be communicated with. The memory store 52 is used to store executable programs and other information, and may include storage means such as conventional disk drives, hard drives, CD ROMS, or any other non volatile memory means. The CPU 54 is used to execute instructions and commands that are loaded from the memory store 52. Peripheral devices 56 such as printers, scanners, and other such devices, may also be connected to both the presenter terminals 14, and viewer terminals 24. The input means 58 allows users to enter commands and information into the respective terminal. As will be understood, terminals may have associated with them one or more input means 58, examples of which may include keyboards, a pointing device such as a mouse, or other means such as microphones. The display terminal 60 provides a display screen, such as a monitor.

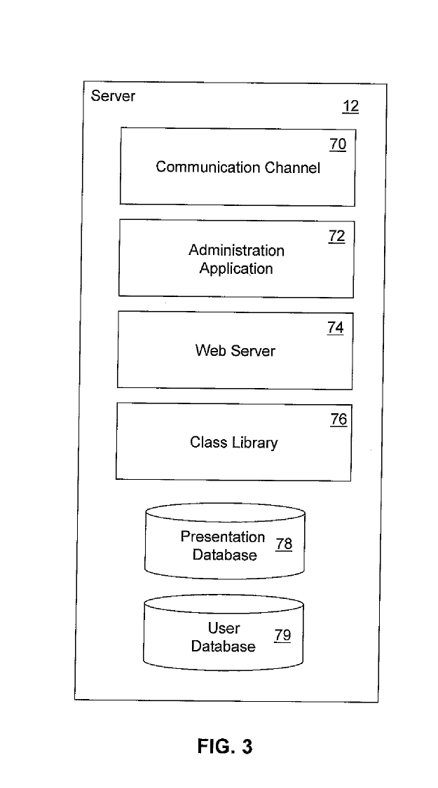

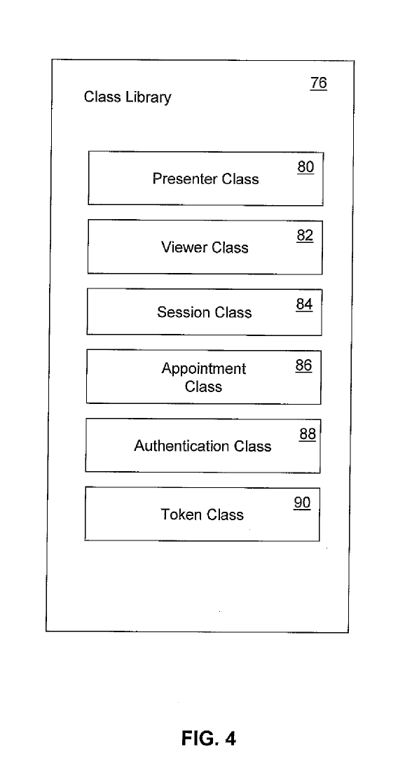

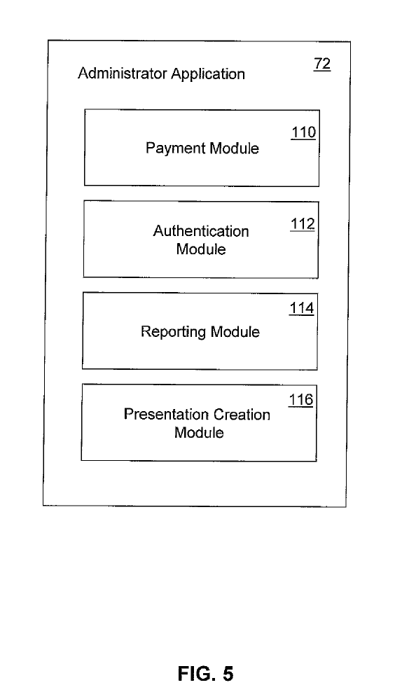

Reference is now made to FIG. 3, where the constituent components of the server 12 are shown in greater detail. The server 12 has associated with it, a communication channel 70, an administrator application 72, a web server 74, a class library 76, a presentation database 78, and a user database 79. The communication channel 70 allows for devices which are able to access the server 12 to engage in various forms of communication with one another. The communication channel 70 allows for data to be transmitted between a sender and receiver. For example, the communication channel may allow text, audio, and video communication between multiple participants who have been granted access to the server 12. The communication channel 70 allows users to communicate directly with one another by means of their respective terminals. Users may communicate with one another through means including text, voice (including voice over IP) and video. The administration application 72 allows for an administrator to administer the system 10 by specifying who may access the system 10. The administration application 72, and more specifically, its constituent components are illustrated in further detail in FIG. 5. The web server 74 allows the system 10 to be accessed via the communication network 22, and more specifically provides one possible means by which presentations are shared. The web server 74 is able to generate messages in response to requests for data; the responses may take the form of web pages, XML messages, Flash pieces, and any other functionality which is used to provide content for viewing on the Internet. The web server 74, is shown for purposes of illustration as residing on the server 12 as a software application, however, it should be understood that in the system 10 the web server 74 may be a dedicated independent computing device. The class library 76 contains classes that are used by the web server 74, along with the administrator application 72. The components of the class library are described in further detail with respect to FIG. 4. The presentation database 78 is used to store presentations that have been created, and that are to be shared through use of the system 10. In alternative embodiments, the presentations may be stored upon the storage means associated with the respective terminals. For example, similar to methods employed for peer to peer communication, the respective presentation files may be stored upon storage means associated with the presenter terminal 14 or the viewer terminal 24. The user database 79 stores the records associated with all presenters and viewers who have access to the system 10, and stores for each user a log recording the presentation sessions they have been associated with. In alternative embodiments, the functionality as provided by the server 12 may be incorporated upon either of the presenter or viewer terminals, so as to allow for direct communication between the respective terminals. By storing a log of the presentation sessions, the presenter and viewer are able to view the presentation they conducted or that were conducted for them at a later time, as the presentation session has been saved.

Reference is now made to FIG. 4, where the components of the class library 76 are shown. FIG. 4 illustrates one embodiment of the classes that are included in the class library 76, and are provided for purposes of illustration, as various other classes may be contained in the class library. Also, the functionality that is present within the classes described with reference to FIG. 4 may be combined into one or more classes. The class library 76, in one embodiment of the invention includes a presenter class 80, a viewer class 82, a session class 84, an appointment class 86, an authentication class 88, and a token class 90. The presenter and viewer classes, 80 and 82 respectively, will contain functionality as described herein that is used for presenters and viewers to share a presentation session. The session class 84 is used to track the presentation sharing session that is undertaken between a viewer and presenter. The appointment class 86 may be used to allow the viewer and presenters to be informed of any presentation sharing sessions that have been scheduled. The authentication class 88 may be used to authenticate both presenters and viewers as having access to the system 10. The token class 90 is used to provide the respective users (either viewers or presenters) with a security token each time access is made to the system 10, which is used to ensure that only authorized users access the system 10.

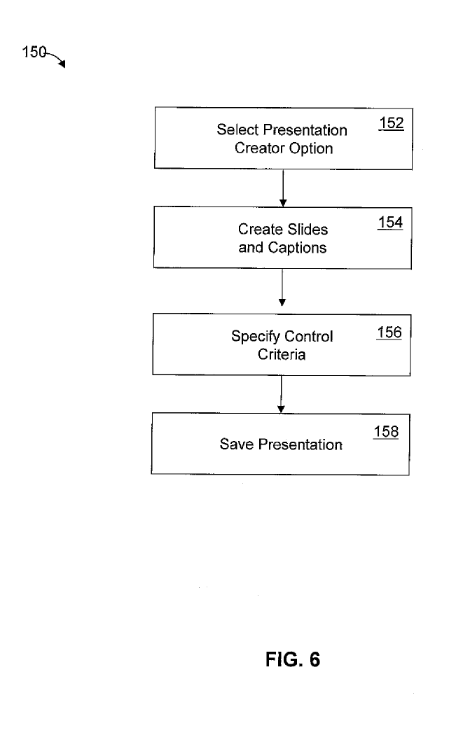

Reference is now made to FIG. 5, where the constituent components of the administrator application 72 in one exemplary embodiment of the invention are shown. The administrator application 72 is comprised of a payment module 110, an authentication module 112, a reporting module 114, and a presentation creation module 118. Access to the administrator application is restricted to trusted users of the system 10. The payment module 110 handles any billings or payments that are associated with use of the system 10. Accessing the system 10 may involve incurring costs depending on the particular set up of the system 10, and as such the payment module 110 may be used to process payments received to use the system 10. The authentication module 112 is used to ensure that only authorized users (both viewers and presenters) are able to access the system. The reporting module 114 is used to keep a record or log of all the users who have accessed the system, and the presentations that they have viewed. The presentation creation module 116 allows for an authorized user to create a presentation that is to be shared. The functionality provided by the presentation creation module 116 is further illustrated in FIG. 6, where the steps of a presentation creation method are shown.

Reference is now made to FIG. 6, where the steps of a presentation creation method 150 are shown. Presentation creation method 150 is undertaken in order to create a presentation that is to be shared between a presenter and viewer.

Presentation creation method 150 begins at step 152, where the user selects an option provided to them to create a presentation. A presentation is created by an author. The author may be a presenter or other individual. The option may be provided as part of the administrator application 72 or as functionality that is present on the Internet where certain users are given permission to access the presentation creation method.

Method 150 then proceeds to step 154, where the presentation information that is to be part of the presentation is specified. For purposes of illustration method 150 is described herein with respect to the creation of presentations comprised of one or more slides.

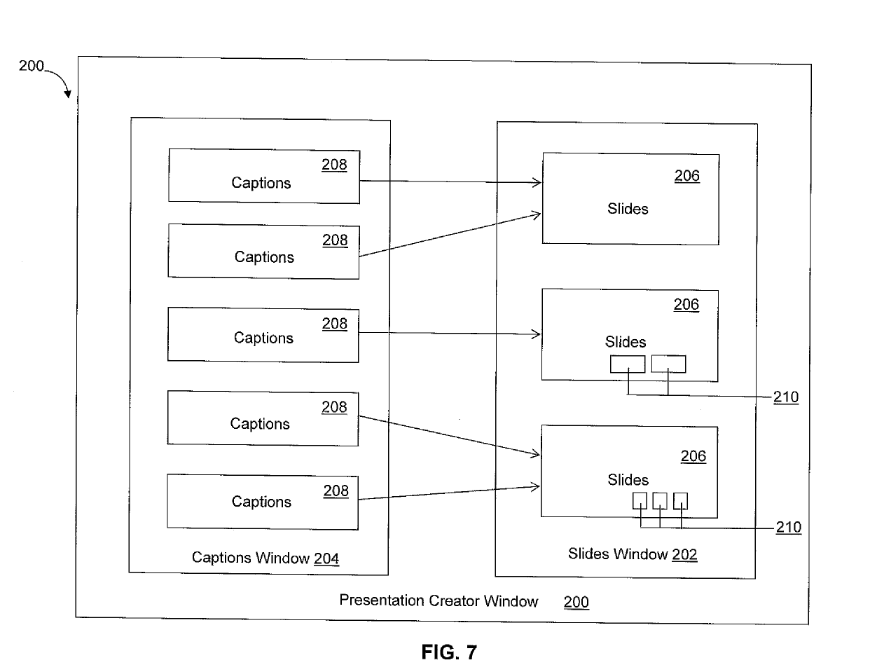

Step 154 is described with reference to FIG. 7, where one exemplary embodiment of a presentation creator window 200 is shown. The presentation creator window 200 is used to create a presentation that is shared between a presenter and a viewer. In this exemplary embodiment, the presentation creator window 200, is used to create a presentation consisting of slides which may include any type of content, and therefore, the presentation creator window 200 contains a slide window 202, and a captions window 204. The author is able to specify that one or more slides 206 are to be included in the presentation by including them in the slides window 202. The author in creating the presentation inserts the slides 206 they wish to appear in the presentation, by inserting the appropriate content, which includes, but is not limited to, text, video, graphics, tables, spreadsheets, documents, or charts into each slide 206. The content may be inserted into the slides 206 through various methods, including a drag and drop method, or inserting the file with which the content is associated through file insertion functionality as is known in the art. In another embodiment, the content that is to appear on the slides, may be created within the slide window 202. In one embodiment, the slide window 202 contains functionality that allows an author to create new slides, edit slides that have been created or specify that no more slides are to be created.

The slide creator window 200 also contains a captions window 204. When creating a slide, any number of captions 208 may be specified for each slide. Captions 208 will contain text that is associated with each slide. Any number of captions 208 may be specified for each slide 206. Captions 208 may contain any text that is specified by the author. Upon the slides 206 and captions 208 having been specified, method 150 proceeds to step 156.

Method 150 then proceeds to step 156. At step 156, the author is able to define control criteria. Control criteria may be embedded into the presentation to provide the presenter with the ability to dynamically determine a sequencing order of the presentation information when conducting a presentation. One method of specifying control criteria, is to incorporate into the presentation, control buttons. Control buttons allow a presenter to control the presentation by changing the presentation which is heard by and/or displayed to the viewer at the viewer terminal 24. Control buttons may include branch buttons, which would allow a presenter, during a presentation, to jump to specified presentation information. Reference is made to FIG. 7, where branch buttons 210 are shown. As shown on FIG. 7, any number of branch buttons 210 may be associated with presentation information, which is being described in this embodiment as a slide 206. The branch buttons 210 included upon a slide 206 will be linked with another slide 206 to which a transition is made when the respective branch button 210 is selected. Branch buttons 210 may also be labeled with specific questions which allow the presenter to navigate the presentation. At step 158, it is also possible for the author of the presentation, as part of the control criteria, to incorporate additional logic that is used to determine the order of the slides in the presentation, such as specifying that certain slides 206 are to be displayed in respect of certain viewers' demographic profiles. For example, certain slides may be displayed to a viewer based on criteria that are defined by the presenter, including age, gender, etc. The demographic information for a user may be stored in the user database 79.

Viewers are also provided control criteria by which they may interact with a presentation. The slides 206 that are included in the viewer file may also include control criteria to allow a viewer to interact with the presentation being delivered. Control criteria may also be included in the presentation to provide the viewer with the ability to affect the sequencing order of the presentation information during a presentation. Control buttons may be labeled with specific questions or options which allow the viewer to express a particular area of interest and/or focus on desired information. By selecting the control buttons the viewer can navigate the presentation jumping to presentation information, for example contained in specified slides. As is discussed above, the control buttons may be branch buttons, . . . , . . . , . . . . In one exemplary embodiment the viewer is provided with control buttons that permit the viewer to navigate a number of different views of an object (e.g. a car).

In a preferred embodiment, more control criteria will be available to the presenter than to the viewer, providing the presenter with more direct control over the course of the presentation and the kind of presentation information that is included in the presentation. Although the participation and input of the viewer is desirable, it will preferably be limited to information requests (e.g. indications of areas of interest or lack of interest, asking questions, confirmation that presentation information has been received and understood, etc.). In contrast, the presenter, who will generally guide the viewer through the presentation or who will conduct the presentation for the benefit of the viewer, will require more direct and comprehensive control of the presentation and, therefore, more control criteria.

Method 150 then proceeds to step 158. At step 158, the user saves the presentation that has been created. The user will specify a name for the presentation, and the presentation is saved upon the server 12 and more specifically is saved in the presentation database 78.

In one exemplary embodiment of the invention, upon the user saving the presentation that has been created, two presentation files are created. In one embodiment of the invention, two flash files are created. The flash files are of type .swf in one embodiment of the invention. The files that are created are referred to as a presenter file and a viewer file respectively. Both files are created based upon the slides 206, captions 208 and control criteria 210 specified in presentation creation method 150. The presenter file contains the slides 206 and captions 208, along with presenter control criteria. The viewer file contains the slides 206, along with viewer control criteria.

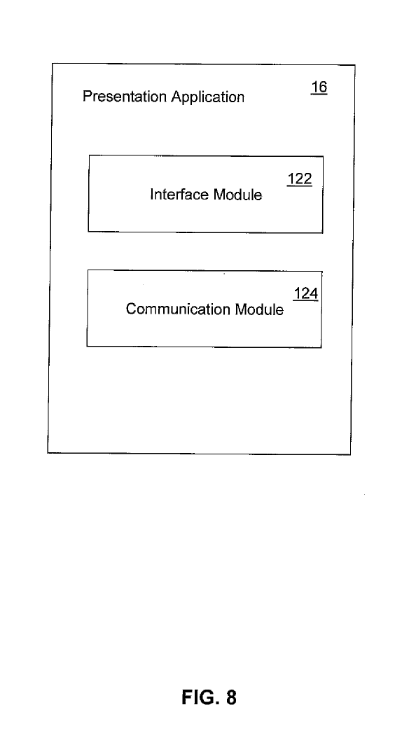

Reference is now made to FIG. 8, where the presentation application 16, and its constituent components are shown. The presentation application, in one exemplary embodiment, contains an interface module 122, and a communication module 124. The interface module 122 allows a user to view a presentation on the display associated with the terminal. In an exemplary embodiment of the invention, the interface module 122 will be Internet technology, such as the Macromedia Flash Plugin. The communication module 124 is used to transmit data between the viewer and presenter terminals via the server 12. The communication module 124 is shown as being part of the presentation application 16, however in alternative embodiments the communication module 124 may be incorporated into software or hardware that is already resident upon or associated with the respective terminals. In an exemplary embodiment of the invention, when the presenter terminal 14 and viewer terminal 24 are communicating with one another through the Internet, the communication module 124 establishes a secure socket connection between the respective terminal and the server 12. The secure socket connection may employ TCP or any other suitable protocol to facilitate a reliable end-to-end authenticated connection between the respective terminals. As the presentation that is being shared between users is resident upon the server 12, the secure socket connection is used to request and receive updates as to the current state of the presentation, including information pertaining to which presentation information should be displayed to the users.

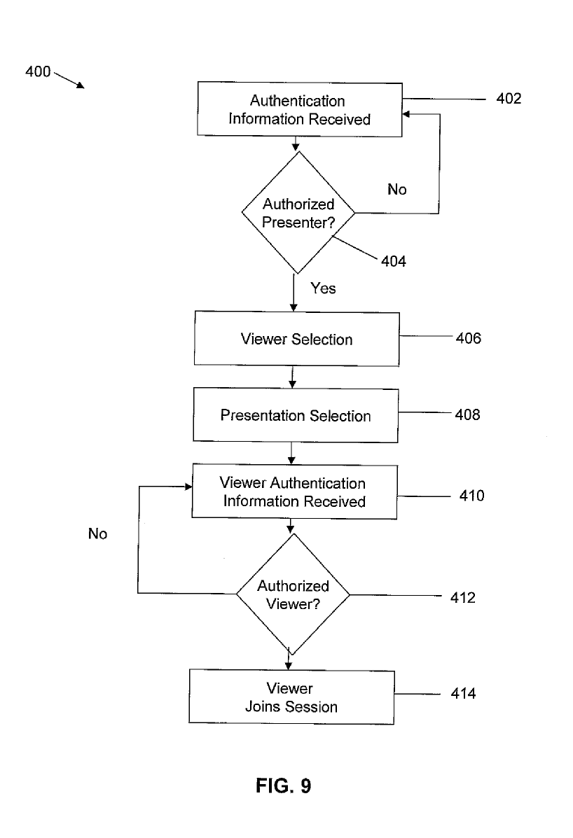

Reference is now made to FIG. 9, where steps of a presentation sharing method 400 are shown. Presentation sharing method 400 illustrates the steps undertaken in order for a presenter and viewer to share a presentation session. Presentation sharing method 400 is described in this embodiment of the invention with respect to the presentations consisting of slides 206, though it may be used to share any type of presentations that have been created.

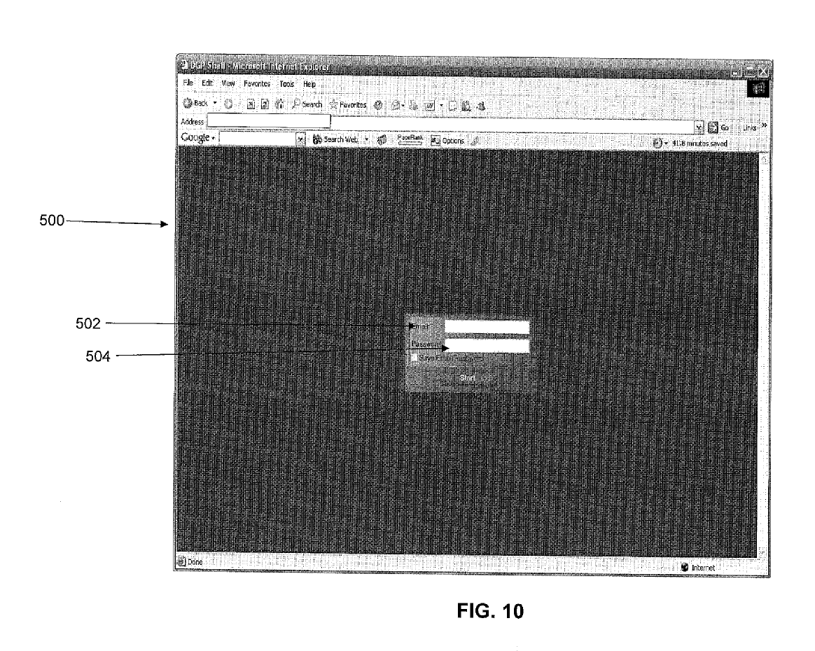

Method 400 begins at step 402, where the presenter is required to provide authentication information in order to be authenticated as a presenter. Reference is made to FIG. 10, where one embodiment of a presenter authentication window 500 is shown. The presenter authentication window contains an e-mail address field 502, and a password field 504. The presenter authentication window 500 is generated by web server 74 and is displayed upon the presenter's terminal 14. The presenter provides their e-mail address and password in the presenter authentication window 500, and method 400 proceeds to step 404. In alternative embodiments, the presenter is able to provide other authentication information such as their name, company, and it is not necessary that an email address be provided in order to be authenticated as a presenter.

At step 404, the authentication module 112 determines whether based on the information provided in step 402, an authorized presenter is attempting access the system 10. If in step 404, it is determined that the information is that of an authorized presenter, method 400 proceeds to step 406. If it is determined in step 404, that the information provided is not that of an authorized presenter, method 400 returns to step 402.

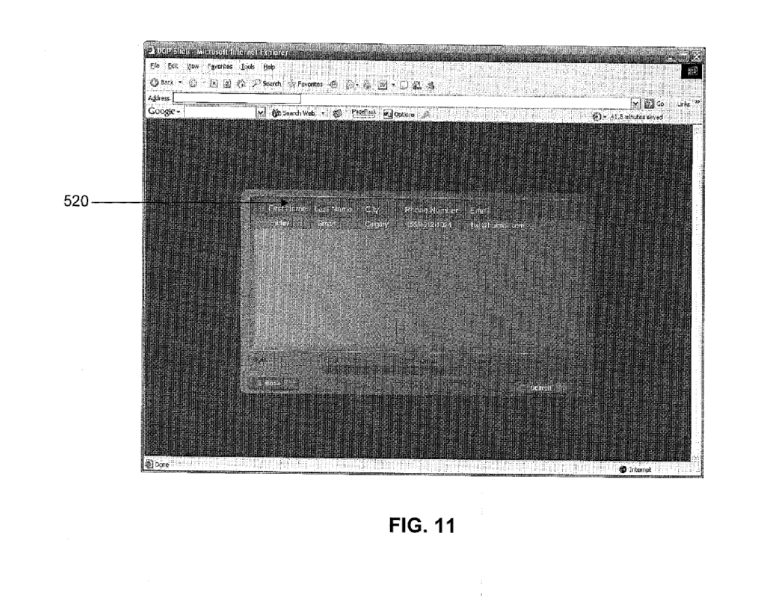

At step 406, the presenter who has been successfully authenticated chooses the viewer with whom they wish to share a presentation session. Reference is made to FIG. 11, where in one embodiment of the invention, the presenter is shown a viewer list window 520. The viewer list window 520 displays a listing of all the viewers that a presenter may share a presentation session with. Upon the presenter selecting the viewer they wish to share a presentation session with, method 400 proceeds to step 408. If the viewer with whom a presenter wishes to share a presentation with is not listed in the viewer list window 520, the presenter has the option of adding the viewer's information to the user database 79 and then selecting them.

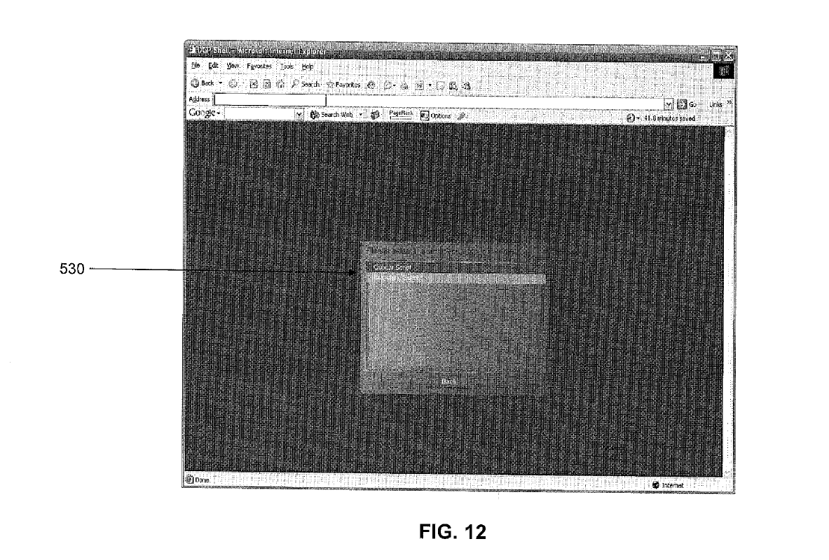

At step 408, the presenter chooses the presentation they wish to share with the viewer. Reference is made to FIG. 12, wherein one exemplary embodiment of the invention, a presentation selection window 530 is displayed. The presentation selection window 530 lists the presentations that may be chosen. Upon a presentation being selected, method 400 proceeds to step 410.

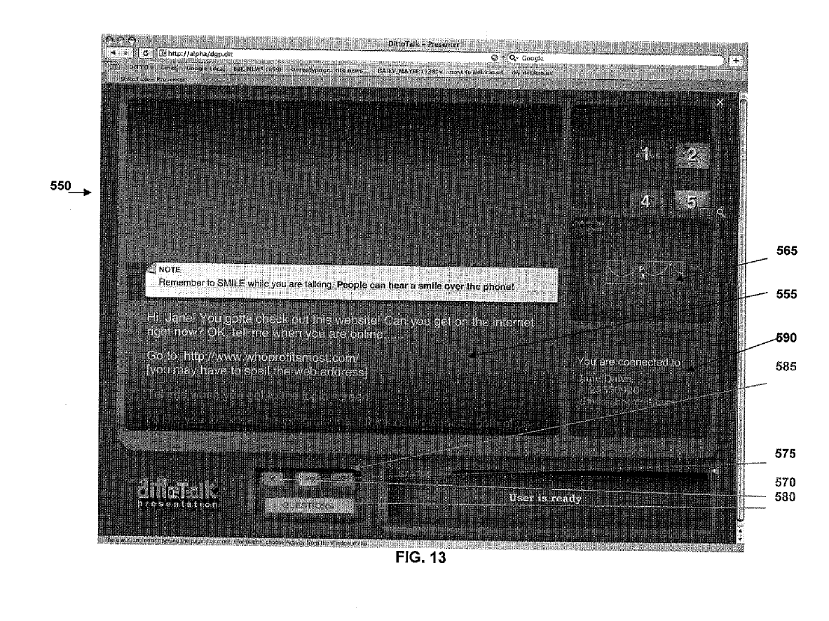

At step 410, the web server 74 causes to be displayed upon the presenter's terminal 14 a presentation control window 550 as shown in FIG. 13. At step 410, the viewer and presenter may be communicating with one another through various means, including the use of the phone or through means provided for via the communication channel 70. In one exemplary embodiment of the invention, functionality is included in window 550 to allow the presenter to control the presentation information that is viewed by the viewer. The presentation control window 550 is generated by the webserver 74, by accessing the presenter file that was created and stored upon the server 12. The control window 550 in one embodiment consists of a captions box 555, control criteria buttons, for example previous slide button 570, subsequent slide button and help button 585, a viewer window 565, and a help button 585. In the embodiment shown in FIG. 13, the spacebar 580, when activated provides information to the presenter as to the state of the presentation.

The captions window 555 displays the captions 208 that were specified by the author when creating the presentation. The viewer window 565 allows the presenter to view the slides that are being shown to the viewer during a presentation session. The previous slide button 570, changes the slide shown to the viewer to the previous slide that was displayed. The subsequent slide button 575, causes the presentation being viewed by the viewer to proceed to a subsequent slide.

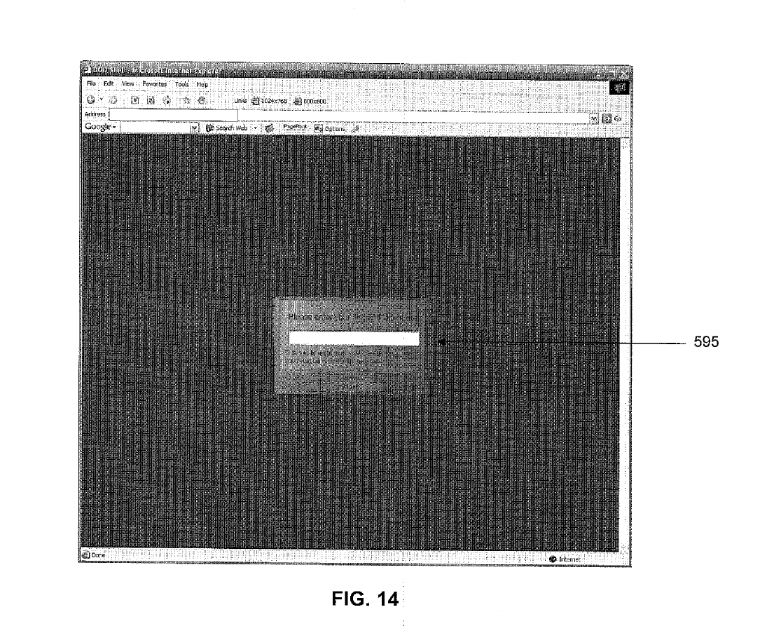

Reference is made to FIG. 14 where a viewer authentication window 595 is shown. At step 410, the viewer visits a website and provides authentication information in order to join the presentation session that has been initiated. In one embodiment, the viewer enters authentication information which may include their first and last name. In an alternative embodiment, other information such as a user ID, email address and password may be entered.

Method 400 then proceeds to step 412, wherein the authentication information provided at step 410 is verified against information contained in the user database 79, by using the authentication module 112. If at step 412 the user is authenticated, method 400 proceeds to step 414. If at step 412 the user is not authenticated, method 400 returns to step 410, wherein further authentication information is requested from the viewer.

Upon the user being authenticated, method 400 proceeds to step 414, and the viewer will have joined the presentation session. Upon the conclusion of method 400, both the presenter and viewer are sharing the same presentation session. When both the presenter and viewer sharing the same presentation session, the presenter is able to conduct a presentation for the viewer. In the alternative embodiments, it is not required that a viewer have joined a presentation session before the presenter conducts a presentation. A general invitation to join in a presentation session may be given to one or more viewers, and a presenter may begin the presentation session with viewers being allowed to join at any time. Method 400 has been used for purposes of illustration as viewers in the system 10 are able to join a presentation session at any time.

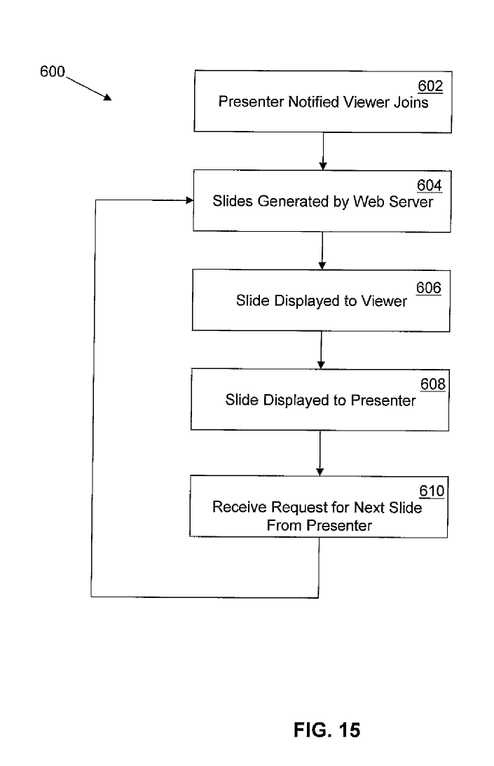

Reference is now made to FIG. 15, where the steps of a presentation conduction method 600 are shown. Presentation sharing method 600 is undertaken after a presenter and viewer have both joined a presentation session. The presentation sharing method 600 and its steps will illustrate how a presentation is conducted by a presenter for a viewer.

Method 600 begins at step 602, where the presenter is notified that a viewer has joined the presentation session. To illustrate one embodiment of a notification method, reference is made again to FIG. 13, where a notification is provided on the connection status window 590. The notification will be displayed to the presenter upon the viewer having been authenticated. In one embodiment, prior to the viewer joining the presentation session, in the viewer window 565 the presenter is shown the first slide that will be shown to the viewer, from the viewer presentation file.

Method 600 then proceeds to step 604. At step 604 the respective slides that are to be viewed by the presenter and viewer are generated at the webserver 74. The slides generated and shown on the viewer terminal as explained above, do not include the captions 208 that have been specified when the presentation was being created. The captions 208 that are displayed to the presenter from the presentation file as shown on presenter terminal 14 may serve as a script that can be followed by a presenter when conducting a presentation for a viewer, or as notes which may aid the presenter in conducting the presentation.

Method 600 then proceeds to step 606, and step 608, where if new slides have been generated by the webserver 74, they are displayed upon the presenter and viewer terminals respectively. The slide that has been generated for the presenter is then displayed to the presenter upon the presenter terminal, and the slide that has been generated for the viewer terminal will be displayed upon the viewer terminal.

Method 600 then proceeds to step 610, where a request is received for new slides to be generated and shown upon both the presenter and viewer terminals, respectively. The presenter may specify that a new slide is to be generated and displayed through various means, including the control criteria, branch buttons, or other functionality. The request is received from the presenter who is conducting the presentation session. Upon the presenter specifying that new slides are to be generated, method 600 returns to step 604, where based on the presenters instructions, new slides are generated upon the webserver 74 for both the presenter and viewer respectively. Method 600 continues until the presenter or viewer quit the presentation session that is being shared.

The server 12, the presenter terminal 14 and viewer terminal 24 are in communication with one another through the socket connection that has been established through the server 12. Therefore, upon the presenter specifying that a new slide is to be displayed the message is transmitted to the server 12 wherein a new slide is generated and it is subsequently displayed to the presenter and viewer terminal respectively. This socket communication allows for instantaneous changes to be made to the presentations being viewed by the viewer in response to a request from the presenter.

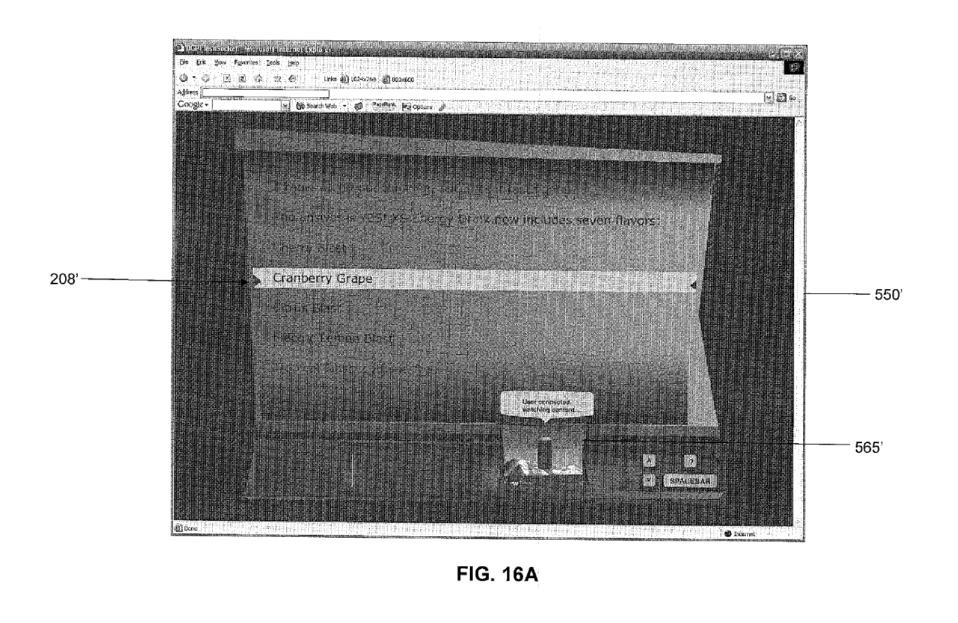

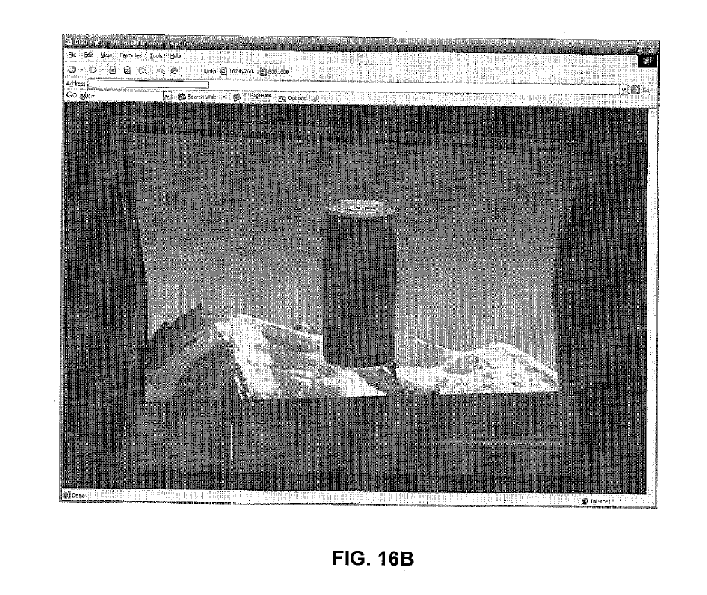

Reference is now made to FIG. 16A and FIG. 16B. FIG. 16A shows another embodiment of a presentation control window 550′. FIG. 16B illustrates a corresponding slide as displayed on a viewer terminal 24. The presentation control window 550′ of FIG. 16A illustrates the captions 208′ as specified in the presentation creation method. The viewer window 565′ allows the presenter to view the presentation as being shown to the viewer, as shown at FIG. 16B.

Presentation conduction method 600 has been illustrated with respect to the generation of slides and their subsequent display upon the presenter and viewer terminals. Presentation creation method 150 may be used to create presentations, which include content other than slides, and therefore, in presentation conduction method 600, a presenter may request for new content to be displayed upon the viewer terminal 24, and this therefore may take the form of various types of content (audio, video, graphics, documents).

In alternative embodiments of the system 10, control criteria may be included on both the slides that are generated for the presenter and viewer respectively. More control of the presentation may be provided to the viewer, wherein the presentation sharing session may be more interactive between the two participants.

In an exemplary embodiment of the invention the presenter is able to control the timing of the viewer's receipt of the presentation information. For example, the next slide, or group of slides may be made available for viewing on the viewer terminal(s) only when authorized by the presenter. This control may be exercised by engaging control criteria available to the presenter on the presentation terminal (e.g. control buttons that advance a slide or group of slides for viewing on the presentation and viewer terminal(s)). For example, the presenter may make the next slide or group of slides available for viewing on the viewer terminal(s) in response to captions on the presentation terminal. In other words, the presenter can follow a script which contemplates advancing the presentation information at predetermined intervals. In an exemplary embodiment the presentation information is advanced by one slide for each caption read by the presenter.

It should be understood that various modifications can be made to the embodiments described and illustrated herein, without departing from the invention, the scope of which is defined in the amended claims.

What is claimed is:

1. A method of delivering a presentation, comprising:
a) establishing a network connection between a viewer terminal and a presenter terminal;
b) selecting at said presenter terminal a presentation, wherein said presentation includes presentation information and one or more control criteria; and
c) displaying said presentation upon said viewer and presenter terminals;
wherein engagement of said control criteria permits selection of a desired portion of said presentation information for display on said terminals.

2. The method of claim 1, wherein identities of said viewer and said presenter are authenticated prior to establishing said network connection.

3. The method of claim 1, wherein said control criteria includes viewer control criteria displayed at said viewer terminal and presenter control criteria displayed at said presenter terminal and wherein said viewer control criteria is different from said presenter control information.

4. The method of claim 1, wherein said viewer terminal is a plurality of viewer terminals.

5. The method of claim 1, wherein a further network connection is established with a further viewer terminal after said display of said presentation has begun.

6. The method of claim 1, wherein the network connection is an Internet connection.

7. The method of claim 1, wherein the presentation information is displayed at the presenter and viewer terminals on a web browser.

8. The method of claim 1, wherein the presentation information includes one or more of slides, audio, graphics, video and captions.

9. The method of claim 1, wherein the presenter terminal and the viewer terminal share a communication channel.

10. The method of claim 9, wherein the communication channel allows for at least one of voice communication, video communication and text communication.

11. The method of claim 1, wherein said control criteria include at least one of a branch button, a subsequent slide button and a preceding slide button.

12. The method of claim 1, further comprising the following step:
a) selecting a desired portion of said presentation information for display on said viewer and presentation terminals by engaging said control criteria.

13. The method of claim 12, wherein said control criteria is one of one of a branch button, a subsequent slide button and a preceding slide button.

14. The method of claim 12, wherein said presentation information includes at least one caption, wherein said captions, and wherein said control criteria is engaged at said presentation terminal directly after said caption is displayed on said presentation terminal.

15. A method of creating a presentation to be displayed on a presenter terminal and a viewer terminal, said method comprising:
(a) specifying presentation information to be included in said presentation;
(b) specifying one or more control criteria and associating said control criteria with said presentation information;
(c) storing said presentation information and control criteria;
wherein engagement of said control criteria from said presenter terminal or said viewer terminal permits selection of desired portions of said presentation information for display on said terminals.

16. The method of claim 15, wherein said control criteria is made up of presenter control criteria and viewer control criteria and wherein said method further comprises the following steps:
(a) generating a presentation file including said presentation information and said presenter control criteria;
(b) generating a viewer file including said presentation information and said viewer control criteria; and
(c) storing said presentation file and said viewer file.

17. The method of claim 15, further comprising the following step:
(a) associating one or more captions with said presentation information.

18. The method of claim 15, wherein the presentation information includes at least one of slides, audio, graphics, video and captions.

19. The method of claim 15, wherein the control criteria includes at least one of a branch button, a subsequent slide button and a preceding slide button.
